(19) United States
(12) Patent Application Publication
(10) Pub. No.: US 2007/0044847 A1
(43) Pub. Date: Mar. 1, 2007

(54) Connecting structure for a check valve

(75) Inventor: Tiao-Hsing Yang, Shengang Township (TW)

Correspondence Address: John S. Egbert;Egbert Law Offices, 7th Floor, 412 Main Street, Houston, TX, 77002, US

(73) Assignee: Yang Fa Men Industrial Co., Ltd., Shengang Township (TW)

(21) Appl. No.: 11/216,346

(22) Filed: Sep. 1, 2005

(51) Int. Cl. F16K 15/03

(52) U.S. Cl. 137/527.8

(57) ABSTRACT

The connecting structure of the check valve has a mounted water-blocking disk placed on the valve base of the check valve and using a pin connection, an inner wall of the valve having two chips, and through holes on the chips outside the valve base having a protruding part and through hole. The chips and the through holes and the through hole of the protruding part are made in one-piece to avoid extra process to avoid extra process and to avoid the poor effect or error, or waste the processing equipment and tools and time spent on processing. When the water-blocking disk is assembled with the pin, the related positions may be more precise, the movement of the water-blocking disk may be completed correctly and smoothly, and it would not have the problems such as being crooked, not closed and leaking.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a connecting structure for check valve, and more particularly to a design with the valve base of the check valve and the pin hole of the water-blocking disk and the U-shaped base of its pin hole, and the U-shaped base and the pin hole are formed in one-piece, so that the degree of preciseness may be more precise in a controllable scope for assembling water-blocking disk, as well as for the movement of the water-blocking disk.

### BACKGROUND OF THE INVENTION

FIGS. 1 and 2 show the perspective view of the current check valve and the operational view of its processed pin hole. The production of the conventional check valve uses rougher molding technology; first, it molds the shape of basic valve base 1, and its connecting surface, such as the terminal surface 3 of the protruding part 2 of its valve base 1, and after that, it drills pin hole 5 on the terminal surface 3 of the protruding part 1 by the drill bit 4, the location of pin hole 5 takes away the width of the location for the U-shaped base 21 of the water-blocking disk 20.

As shown in FIG. 4, after taking away the location for the U-shaped base 21 of the water-blocking disk 20, both sides inside the valve base must form two protruding parts 6, 7, and between the two protruding part 6, 7 must have the width of the U-shaped base 21 for the water-blocking disk 20 that in the air, and after the drill bit drills one side of a protruding part 6, it creates the oscillating effect in the air, which can easily cause the pin hole expands in a cone fashion, on the other hand, the drill bit 4 must drill the hole on the other side of the protruding part 7, however, because it is hard to find a correct pin hole 8 on a flat surface, and with the part of the drill bit hangs in the air, which may cause the hole 8 is drilled crooked, and makes it hard for these two holes 5, 8 to line up for the pin to go through.

As shown in FIG. 4, the water-blocking disk 20 is more difficult, and it may cause the water-blocking disk become crooked in the future, and cause leakage, and it is being used in the location with high pressure, therefore, the leakage is easy to cause danger.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The check valve may be formed in one-piece with the ear-like chip, its through hole, and the through hole of the protruding part to avoid extra process to improve the effect. Because extra processing can cause error in degree of the preciseness or waste the processing equipment and material, and it is time consuming. When the water-blocking disk is assembled with pin, the related positions may be more precise, the movement of the water-blocking disk may be completed correctly and smoothly, and it would not have the problems such as being crooked, not closed and leaking.

To sum up, the connecting structure for the check valve of the present invention uses one-piece formed by connecting the through holes between the ear-like chips of the water-blocking disk to the valve base, so that the degree of preciseness of the ear-like chips inside the valve base and their through holes may reach the requirement of preciseness and avoid extra processing; and because of the degree of preciseness is high and it is assembled easily, so that the movement of water-blocking disk is more accurate, and the effect of check valve may be achieved. Therefore, it may be safe to use the check valve under the high pressure, and to have better practicability among the same type of products. The present invention qualifies for the requirement for patent and applies for patent accordingly.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the perspective view of the conventional check valve.

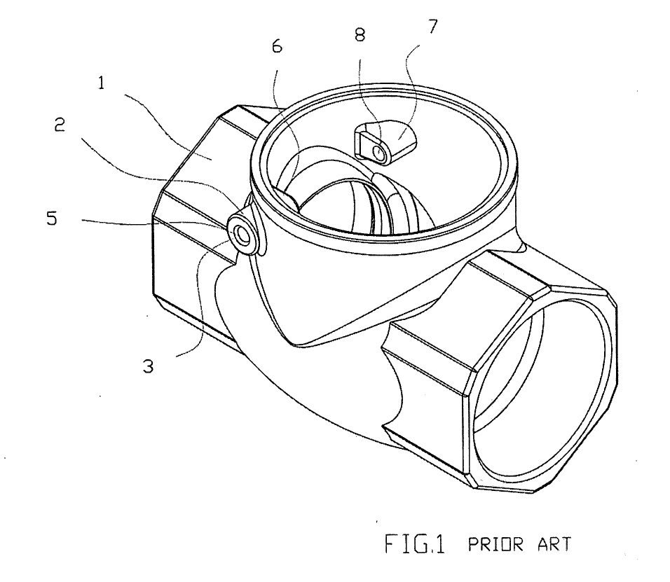

FIG. 2 shows a schematic view of drilling the pin hole of the check valve.

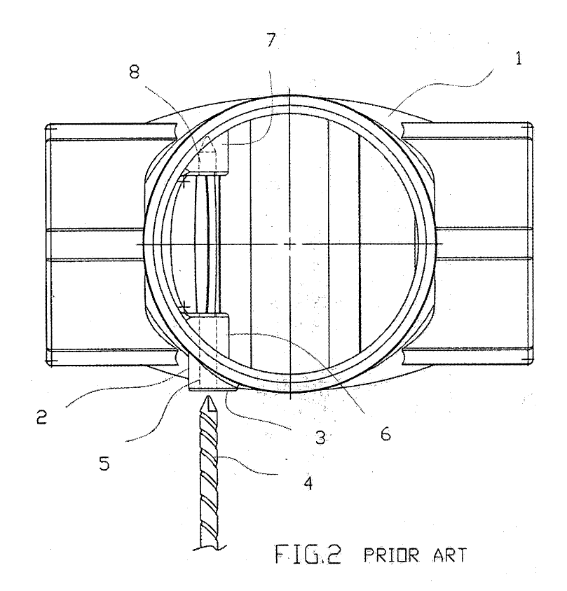

FIG. 3 shows the perspective view of the preferred embodiment of the connecting structure for the check valve of the present invention.

FIG. 4 shows a cross-sectional view of the preferred embodiment of the connecting structure for the check valve of the present invention.

FIG. 5 shows an elevation view of the preferred embodiment of the connecting structure for the check valve of the present invention.

FIG. 6 shows another elevation view of the preferred embodiment of the connecting structure for the check valve of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

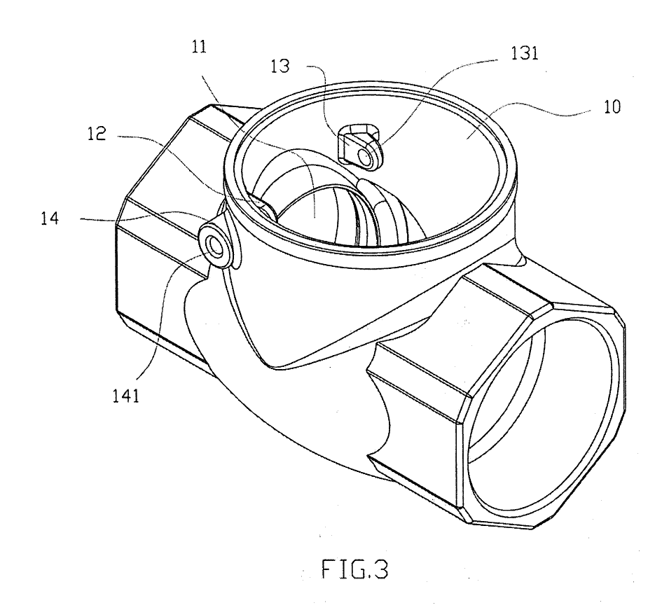

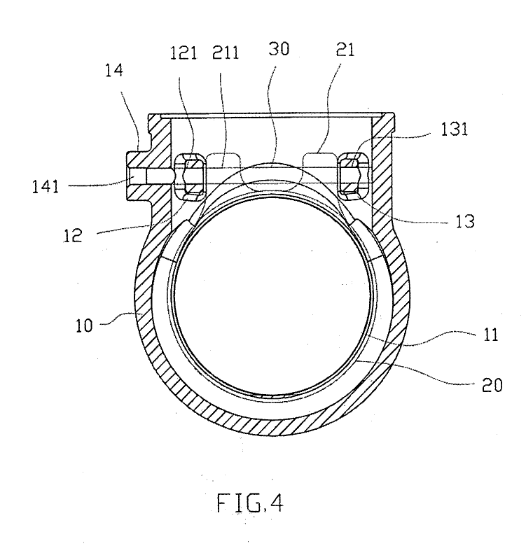

FIGS. 3 and 4 show the perspective view of the preferred embodiment and the sectional view of the present invention. The connecting structure for the check valve includes a valve base 10 of the check valve and the water-blocking disk 20; the valve base 10 includes a contracted neck 1, two ear-like chips 12, 13 and a protruding part 14, and the protruding part 14 and two ear-like chips 12, 13 have through holes 141, 121, 131 on them; the water-blocking disk 20 includes the U-shaped base 21, and the U-shaped base 21 also has through hole 211; a pin 30 that goes through the through hole 141 of the protruding part 14 and the through hole 121 on the ear-like chip 12, and the through hole 211 of the U-shaped base 21 of the water-blocking disk 20 and the through hole 131 of the ear-like chip 13 to achieve the objective of pining the water-blocking disk 20 to the valve base 10.

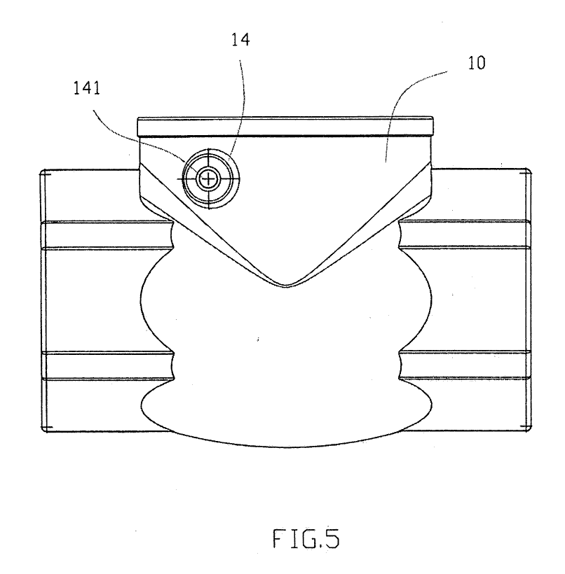

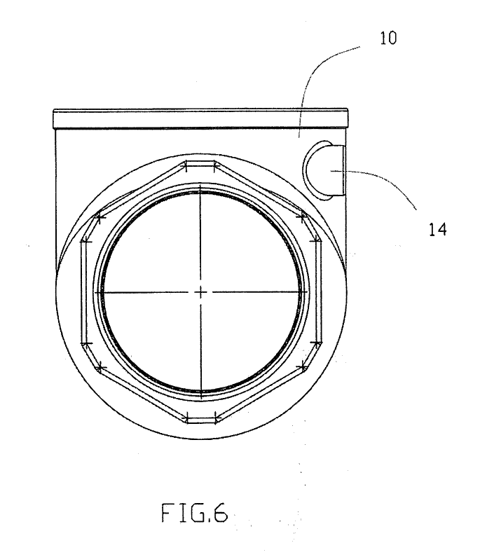

FIGS. 4, 5 and 6 show the sectional view, lateral view, and front view of the preferred embodiment of the present invention, the location where the water-blocking disk 20 is placed on the valve base 10 of the check valve, especially the water-blocking disk 20 that uses pin connection, inside the valve base 10 of the check valve where it corresponds has a contracted neck 11, and the position of the contracted neck 11 is pushed forward on the bottom, and the upper wall of the contracted neck 11 has two ear-like chips 12, 13, and the through holes 121, 131 on the ear-like chips 12, 13 outside the valve base 10 have protruding part 14 and through hole 141, and the through hole 141 of the protruding part 14 of the valve base 10 lines up with the through holes 121, 131 of the ear-like chip 12, 13 inside, and the through holes between the ear-like chip 12 and ear-like chip 13 are lined up as well, in which the ear-like chip 12 ,13 and the through holes 121, 131 and the through hole 141 of the protruding part 14 are made in one-piece to avoid extra process, and when the water-blocking disk 20 is assembled with pin 30, the related positions may be more precise, and the movement of the water-blocking disk 20 may be completed correctly and smoothly, and it would not have the problems such as being crooked, not closed and leaking.

The one-piece forming method mentioned above may be achieved by de-waxing casting, gravity casting, shell casting and sand casting.

I claim:

1. A connecting structure for check valve, comprising:
a valve base;
a water-blocking disk pinned to the valve base; the valve base being connected by through holes of ear-like chips and a protruding part; the valve base and two ear-like chips and through holes of the ear-like chips and the through hole of the protruding part being formed in one-piece, a degree of preciseness between the through holes being reached to avoid extra through hole processing;
wherein the degree of preciseness between the through holes have reached a requirement that makes assembly smoother and movement of the water-blocking disk more accurate, a sealing effect being greater under high, low or no pressure environment to avoid poor effect or error, or waste of processing equipment and tools and time spent on processing.

2. The structure defined in claim 1, wherein the valve base and two ear-like chips and through holes of the ear-like chips and the through hole of the protruding part are comprised of a de-waxing casting.

3. The structure defined in claim 1, wherein the valve base and two ear-like chips and through holes of the ear-like chips and the through hole of the protruding part are comprised of a gravity casting.

4. The structure defined in claim 1, wherein the valve base and two ear-like chips and through holes of the ear-like chips and the through hole of the protruding part are comprised of a shell casting.

5. The structure defined in claim 1, wherein the valve base and two ear-like chips and through holes of the ear-like chips and the through hole of the protruding part are comprised of a sand casting.
